(19) United States
(12) Patent Application Publication
(10) Pub. No.: US 2017/0012820 A1
(43) Pub. Date: Jan. 12, 2017

(54) INFORMATION PROCESSING SYSTEM AND INFORMATION PROCESSING METHOD

(71) Applicants: Takayuki INOUE, Kanagawa (JP); Hozumi YONEZAWA, Tokyo (JP)

(72) Inventors: Takayuki INOUE, Kanagawa (JP); Hozumi YONEZAWA, Tokyo (JP)

(73) Assignee: Ricoh Company, Ltd., Tokyo (JP)

(21) Appl. No.: 15/194,605

(22) Filed: Jun. 28, 2016

(30) Foreign Application Priority Data
Jul. 10, 2015 (JP) 2015-139156

(51) Int. Cl. H04L 12/24

(52) U.S. Cl. CPC H04L 41/0806; H04L 41/082

(57) ABSTRACT

Each device includes: a processing-information-request transmitter configured to transmit a processing information request containing device identification information identifying the device, to an information processing apparatus based on detection of a mobile terminal; a first processing-information receiver configured to receive processing information from the information processing apparatus; and a first processing-information transmitter configured to transmit the processing information to the mobile terminal. The information processing apparatus includes: a processing-information-request receiver configured to receive the processing information request from each device; a second processing-information transmitter configured to retrieve processing information associated with the device identification information contained in the processing information request and transmit the processing information to the device of the transmission source. The mobile terminal includes a processing unit configured to execute predetermined processing which is made executable if a plurality of pieces of processing information are received from the plurality of devices.

### CROSS-REFERENCE TO RELATED APPLICATION(S)

The present application claims priority under 35 U.S.C. §119 to Japanese Patent Application No. 2015-139156 filed on Jul. 10, 2015. The contents of which are incorporated herein by reference in their entirety.

### BACKGROUND OF THE INVENTION

1. Field of the Invention

The present invention relates to an information processing system and an information processing method.

2. Description of the Related Art

A technique of executing a service on a mobile terminal whose location satisfies a condition for providing the service is conventionally known (e.g. Japanese Laid-open Patent Publication No. 2014-199654).

However, the typical technique as described above and known to the inventors controls only whether or not to execute predetermined processing depending on location of a mobile terminal and cannot make a condition for making the predetermined processing executable, complex.

### SUMMARY OF THE INVENTION

According to an aspect of the present invention, an information processing system includes a plurality of devices, an information processing apparatus, and a mobile terminal. Each of the plurality of devices includes a detection unit, a processing-information-request transmitter, a first processing-information receiver, and a first processing-information transmitter. The detection unit is configured to detect the mobile terminal. The processing-information-request transmitter is configured to transmit a processing information request containing device identification information identifying the device, to the information processing apparatus based on detection of the mobile terminal by the detection unit. The first processing-information receiver is configured to receive processing information associated with the device identification information contained in the processing information request, from the information processing apparatus. The first processing-information transmitter is configured to transmit the processing information to the mobile terminal. The information processing apparatus includes a processing-information-request receiver and a second processing-information transmitter. The processing-information-request receiver configured to receive the processing information request from each of the plurality of devices. The second processing-information transmitter configured to retrieve, from a storage unit configured to store different pieces of processing information in association with respective pieces of device identification information, processing information associated with the device identification information contained in the received processing information request and transmit the processing information to the device, from which the processing information request has been transmitted. The mobile terminal includes a second processing-information receiver and a processing unit. The second processing-information receiver is configured to receive processing information from each of the plurality of devices. The processing unit configured to execute predetermined processing which is made executable if a plurality of pieces of processing information are received from the plurality of devices, based on the plurality of pieces of processing information.

### BRIEF DESCRIPTION OF THE DRAWINGS

FIG. 1 is a block diagram illustrating an example of a configuration of an information processing system of an embodiment;

FIG. 2 is a block diagram illustrating an example of hardware components of a mobile terminal of the present embodiment;

FIG. 3 is a block diagram illustrating an example of hardware components of a device of the present embodiment;

FIG. 4 is a block diagram illustrating an example of hardware components of an information processing apparatus of the present embodiment;

FIG. 5 is a block diagram illustrating an example of a configuration of the information processing system of the present embodiment;

FIG. 6 is a diagram illustrating an example of information stored in a storage unit of the present embodiment;

FIG. 7 is a diagram illustrating an example of a predetermined order of the present embodiment;

FIG. 8 is a sequence diagram illustrating an example of processing to be executed in the information processing system of the present embodiment;

FIG. 9 is a flowchart illustrating an example of processing to be executed when processing information or error information is received by the mobile terminal of the present embodiment;

FIG. 10 is a view illustrating an example notification of the present embodiment;

FIG. 11 is a view illustrating another example notification of the present embodiment;

FIG. 12 is a view illustrating still another example notification of the present embodiment; and

FIG. 13 is a view illustrating still another example notification of the present embodiment.

The accompanying drawings are intended to depict exemplary embodiments of the present invention and should not be interpreted to limit the scope thereof. Identical or similar reference numerals designate identical or similar components throughout the various drawings.

### DETAILED DESCRIPTION OF THE PREFERRED EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Exemplary embodiments of the present invention are described in detail below with reference to the accompanying drawings.

An object of an embodiment is to provide an information processing system and an information processing method capable of making a condition for making a predetermined processing executable, complex.

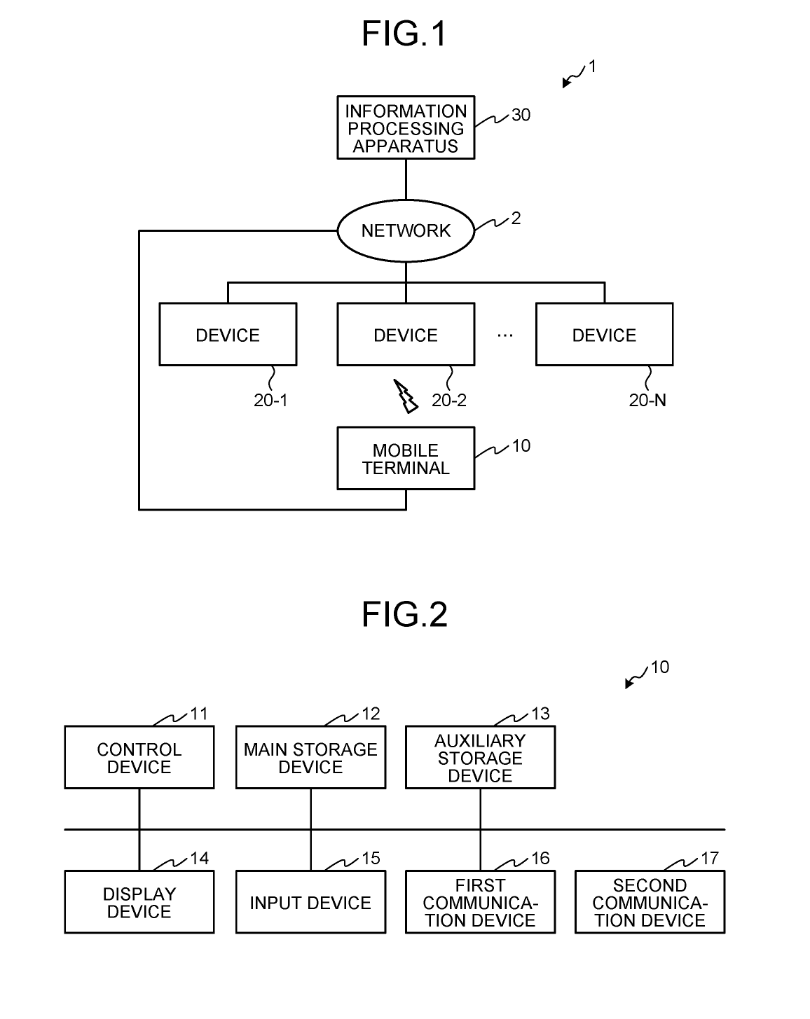

FIG. 1 is a block diagram illustrating an example of a configuration of an information processing system 1 of an embodiment. As illustrated in FIG. 1, the information processing system 1 includes a mobile terminal 10, devices 20-1 to 20-N (N is a natural number greater than 1), and an information processing apparatus 30.

The mobile terminal 10 and each of the devices 20-1 to 20-N are configured to be capable of conducting wireless communication. The present embodiment is described using an example where the mobile terminal 10 and each of the devices 20-1 to 20-N are configured to be capable of conducting wireless communication over short-distance wireless communication, such as NFC (Near Field Communication) and Bluetooth (registered trademark). However, the wireless communication to be used are not limited thereto, and the mobile terminal 10 and each of the devices 20-1 to 20-N may alternatively be configured to be capable of conducting communication over ordinary wireless communication.

The mobile terminal 10, the devices 20-1 to 20-N, and the information processing apparatus 30 are connected over a network 2. Examples of the network 2 include a LAN (Local Area Network) and the Internet.

Hereinafter, the term “device 20” may be used to denote one of the devices 20-1 to 20-N when it is unnecessary to individually distinguish the devices 20-1 to 20-N.

The mobile terminal 10 is a terminal configured to be carried (handheld) by a user. Examples of the mobile terminal 10 include, but are not limited to, a smart device, a notebook PC (Personal Computer), and a mobile phone.

Examples of the device 20 include, but are not limited to, an image forming apparatus, such as a printer apparatus, a copier, an MFP (Multifunction Peripheral), a scanner apparatus, and a facsimile apparatus, a variety of electronic equipment, such as a projector, a teleconference terminal, a digital whiteboard, a digital signage device, a karaoke machine, an electronic game machine, an air conditioner, a refrigerator, a fluorescent lamp, and a vending machine, and a wireless device, such as an access point. The MFP is an apparatus having at least two functions of a copier function, a printer function, a scanner function, and a facsimile function.

The information processing apparatus 30 is a server apparatus that conducts communication with the mobile terminal 10 via the device 20 to provide processing information to the mobile terminal 10. Examples of the information processing apparatus 30 include, but are not limited to, one or more computers. Examples of the processing information include data and program instructions (hereinafter, “program”).

FIG. 2 is a block diagram illustrating an example of hardware components of the mobile terminal 10 of the present embodiment. As illustrated in FIG. 2, the mobile terminal 10 includes a control device 11, such as a CPU (Central Processing Unit) and a GPU (Graphics Processing Unit), a main storage device 12, such as a ROM (Read Only Memory) and a RAM (Random Access Memory), an auxiliary storage device 13, such as an HDD (Hard Disk Drive) and an SSD (Solid State Drive), a display device 14, such as a display, an input device 15, such as a touch panel and a key switch, a first communication device 16, which is a communication interface for short-distance wireless communication, and a second communication device 17, which is a communication interface for the network 2. Hence, the mobile terminal 10 has general-computer-based hardware architecture.

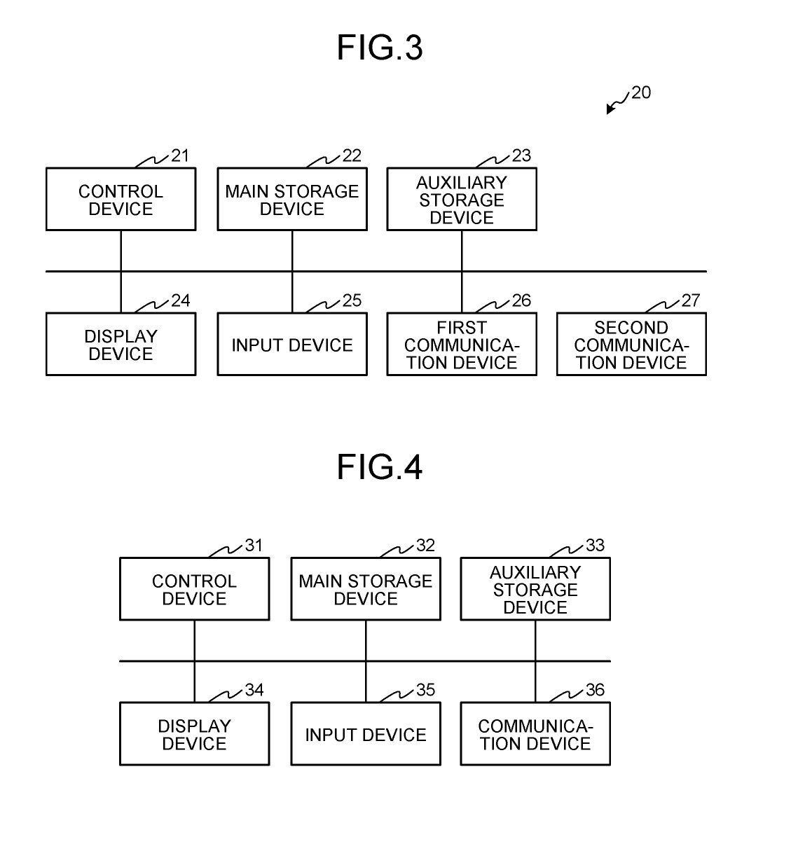

FIG. 3 is a block diagram illustrating an example of hardware components of the device 20 of the present embodiment. As illustrated in FIG. 3, the device 20 includes a control device 21, such as a CPU and a GPU, a main storage device 22, such as a ROM and a RAM, an auxiliary storage device 23, such as an HDD and an SSD, a display device 24, such as a display, an input device 25, such as a touch panel and a key switch, a first communication device 26, which is a communication interface for short-distance wireless communication, and a second communication device 27, which is a communication interface for the network 2. Hence, the device 20 has general-computer-based hardware architecture.

The device 20 may further include, in addition to the components described above, a hardware component, such as an IC (Integrated Circuit), an ASIC (Application Specific Integrated Circuit), and a sensor of a variety of types, specific to the device 20.

FIG. 4 is a block diagram illustrating an example of hardware components of the information processing apparatus 30 of the present embodiment. As illustrated in FIG. 4, the information processing apparatus 30 includes a control device 31, such as a CPU and a GPU, a main storage device 32, such as a ROM and a RAM, an auxiliary storage device 33, such as an HDD and an SSD, a display device 34 such as a display, an input device 35, such as a touch panel, a mouse, and a keyboard, and a communication device 36, which is a communication interface for the network 2. Hence, the information processing apparatus 30 has general-computer-based hardware architecture. The auxiliary storage device 33, the display device 34, the input device 35, and the communication device 36 may be either built in or externally connected to the information processing apparatus 30.

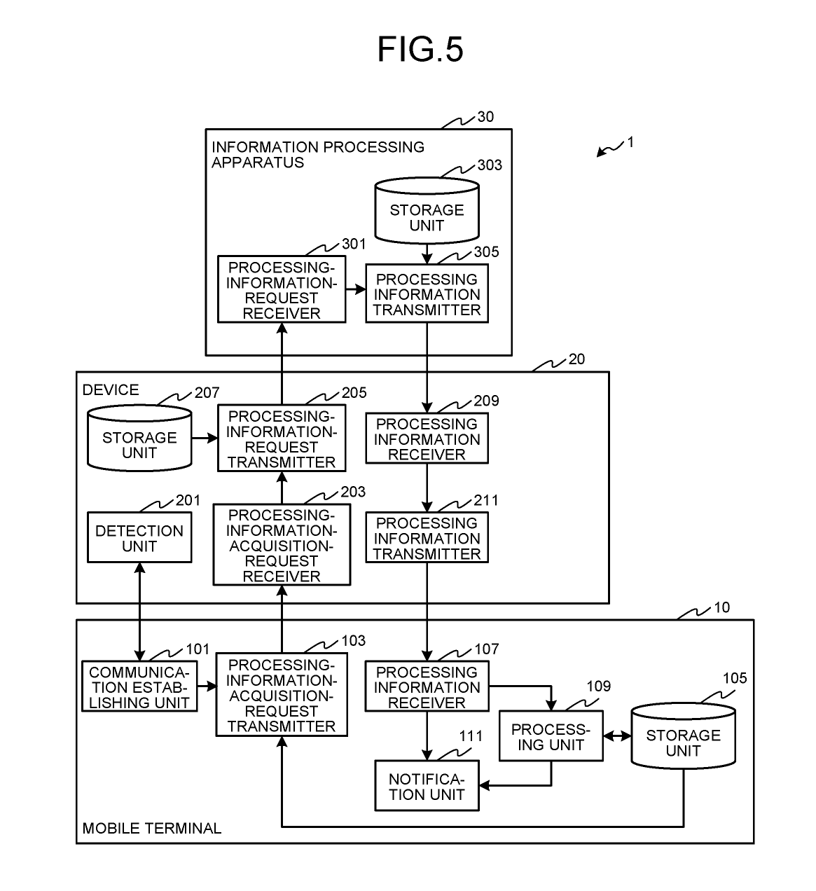

FIG. 5 is a block diagram illustrating an example of a configuration of the information processing system 1 of the present embodiment. As illustrated in FIG. 5, the mobile terminal 10 includes a communication establishing unit 101, a processing-information-acquisition-request transmitter 103, a storage unit 105, a processing information receiver 107 (an example of “second processing-information receiver”), a processing unit 109, and a notification unit 111.

The communication establishing unit 101, the processing-information-acquisition-request transmitter 103, and the processing information receiver 107 can be implemented by, for example, the control device 11, the main storage device 12, and the first communication device 16. The storage unit 105 can be implemented by, for example, the auxiliary storage device 13. The processing unit 109 can be implemented by, for example, the control device 11, the main storage device 12, and the second communication device 17. The notification unit 111 can be implemented by, for example, the control device 11 and the main storage device 12.

The present embodiment is described through an example where the communication establishing unit 101, the processing-information-acquisition-request transmitter 103, the processing information receiver 107, the processing unit 109, and the notification unit 111 are functions of an application program (hereinafter, “application”) installed on the mobile terminal 10; however, implementation of the units is not limited thereto.

As illustrated in FIG. 5, the device 20 includes a detection unit 201, a processing-information-acquisition-request receiver 203, a processing-information-request transmitter 205, a storage unit 207, a processing information receiver 209 (an example of “first processing-information receiver”), and a processing information transmitter 211 (an example of “first processing-information transmitter”).

The detection unit 201, the processing-information-acquisition-request receiver 203, and the processing information transmitter 211 can be implemented by, for example, the control device 21, the main storage device 22, and the first communication device 26. The processing-information-request transmitter 205 and the processing information receiver 209 can be implemented by, for example, the control device 21, the main storage device 22, and the second communication device 27. The storage unit 207 can be implemented by, for example, the main storage device 22 or the auxiliary storage device 23.

As illustrated in FIG. 5, the information processing apparatus 30 includes a processing-information-request receiver 301, a storage unit 303, and a processing information transmitter 305 (an example of “second processing-information transmitter”). The processing-information-request receiver 301 and the processing information transmitter 305 can be implemented by, for example, the control device 31, the main storage device 32, and the communication device 36. The storage unit 303 can be implemented by, for example, the auxiliary storage device 33.

The communication establishing unit 101 issues a request for establishing short-distance wireless communication and establishes short-distance wireless communication with the destination (the device 20) of the short-distance wireless communication. Specifically, the communication establishing unit 101 transmits a request for establishing short-distance wireless communication based on an operation input by a user carrying the mobile terminal 10 using the input device 15. When a response is returned from the destination of the short-distance wireless communication, the communication establishing unit 101 establishes short-distance wireless communication with the destination.

The request for establishing short-distance wireless communication contains at least mobile-terminal identification information identifying the mobile terminal 10, such as an ID of the mobile terminal 10. The mobile-terminal identification information indicating the mobile terminal 10 is stored in, for example, the main storage device 12 or the auxiliary storage device 13.

The detection unit 201 detects the mobile terminal 10. Specifically, the detection unit 201 detects the mobile terminal 10 upon receiving a request for establishing short-distance wireless communication from the communication establishing unit 101 of the mobile terminal 10 placed at a distance where the device 20 can conduct short-distance wireless communication with the mobile terminal 10. The detection unit 201 sends a response to the detected mobile terminal 10 and establishes short-distance wireless communication with the communication establishing unit 101. Thereby, short-distance wireless communication between the mobile terminal 10 and the device 20 is enabled.

The processing-information-acquisition-request transmitter 103 transmits a processing-information acquisition request containing processing-information identification information identifying processing information derived from a latest received processing information, to the device 20 having detected the mobile terminal 10. Specifically, the processing-information-acquisition-request transmitter 103 transmits the processing-information acquisition request to the device 20, with which the short-distance wireless communication is established, over the short-distance wireless communication.

As described above, the processing information, examples of which include data and a program, is transmitted from the information processing apparatus 30 to the mobile terminal 10, and is stored in the storage unit 105.

The processing information derived from the latest received processing information may be either the latest received processing information itself or processing information created from one or more pieces of processing information including the latest received processing information. The processing information created from one or more pieces of processing information including the latest received processing information is created by the processing unit 109.

The storage unit 105 stores, in association with the processing information, the processing-information identification information identifying the processing information, such as an ID of the processing information, date-and-time information indicating the date and time when the processing information is received or created, and/or the like.

In the present embodiment, when the short-distance wireless communication with the device 20 is established, the processing-information-acquisition-request transmitter 103 retrieves processing-information identification information indicating processing information associated with date-and-time information indicating latest date and time, from the storage unit 105, and transmits a processing-information acquisition request containing the retrieved processing-information identification information to the device 20 over the short-distance wireless communication.

When no processing information is transmitted from the information processing apparatus 30 to the mobile terminal 10 and therefore no received processing information is stored in the storage unit 105, processing-information identification information contained in a processing-information acquisition request transmitted to the device 20 by the processing-information-acquisition-request transmitter 103 indicates that there is no processing information.

The processing-information-acquisition-request receiver 203 receives the processing-information acquisition request from the mobile terminal 10 detected by the detection unit 201. Specifically, the processing-information-acquisition-request receiver 203 receives the processing-information acquisition request from the mobile terminal 10, with which the short-distance wireless communication is established, over the short-distance wireless communication.

Based on detection of the mobile terminal 10 by the detection unit 201, the processing-information-request transmitter 205 transmits a processing information request containing device identification information identifying the device itself (the device 20), to the information processing apparatus 30. Examples of the device identification information indicating the device 20 include, but are not limited to, an ID, a serial number, and an IP address of the device 20. The device identification information indicating the device 20 is stored in the storage unit 207.

Specifically, when a processing-information acquisition request is received by the processing-information-acquisition-request receiver 203, the processing-information-request transmitter 205 acquires the processing-information identification information from the processing-information acquisition request and retrieves the device identification information indicating the device 20 from the storage unit 207. The processing-information-request transmitter 205 transmits the processing information request containing the retrieved device identification information indicating the device 20 and the acquired processing-information identification information to the information processing apparatus 30 over the network 2.

The processing-information-request receiver 301 receives the processing information request from each of the devices 20-1 to 20-N. Specifically, the processing-information-request receiver 301 receives the processing information request from each of the devices 20-1 to 20-N over the network 2.

The storage unit 303 stores different pieces of processing information in association with respective pieces of device identification information. In the present embodiment, the storage unit 303 further stores different pieces of processing-information identification information in association with the respective pieces of device identification information.

In the present embodiment, the pieces of processing-information identification information and the pieces of processing information are associated with the pieces of device identification information so as to make an order, in which the user carrying the mobile terminal 10 moves to the devices 20-1 to 20-N, a predetermined order. For this reason, processing-information identification information associated with processing information is not processing-information identification information indicating the processing information but processing-information identification information indicating other processing information. How the pieces of device identification information, the pieces of processing-information identification information, and the pieces of processing information are specifically associated in the storage unit 303 will be described below.

The processing information transmitter 305 retrieves processing information associated with the device identification information contained in the processing information request received by the processing-information-request receiver 301, from the storage unit 303, and transmits the processing information to the device 20, which is the transmission source of the processing information request. Specifically, the processing information transmitter 305 retrieves the processing information associated with the device identification information and with the processing-information identification information, both contained in the processing information request received by the processing-information-request receiver 301, from the storage unit 303, and transmits the processing information to the device 20, which is the transmission source of the processing information request, over the network 2.

When processing information that is associated with the device identification information and with the processing-information identification information, both contained in the processing information request received by the processing-information-request receiver 301, is not stored in the storage unit 303 and therefore the processing information transmitter 305 fails to acquire the processing information, the processing information transmitter 305 transmits error information indicating an error to the device 20, which is the transmission source of the processing information request, over the network 2.

The processing information receiver 209 receives the processing information associated with the device identification information contained in the processing information request transmitted from the processing-information-request transmitter 205, from the information processing apparatus 30. Specifically, the processing information receiver 209 receives the processing information associated with the device identification information and with the processing-information identification information, both contained in the processing information request transmitted from the processing-information-request transmitter 205, over the network 2 from the information processing apparatus 30.

When processing information associated with the device identification information and with the processing-information identification information, both contained in the processing information request transmitted from the processing-information-request transmitter 205, does not exist in the information processing apparatus 30, the processing information receiver 209 receives the error information from the information processing apparatus 30 over the network 2.

The processing information transmitter 211 transmits the processing information received by the processing information receiver 209 to the mobile terminal 10 detected by the detection unit 201. Specifically, the processing information transmitter 211 transmits the processing information received by the processing information receiver 209 to the mobile terminal 10, with which the short-distance wireless communication is established, over the short-distance wireless communication.

If the error information is received by the processing information receiver 209, the processing information transmitter 211 transmits the error information to the mobile terminal 10, with which the short-distance wireless communication is established, over the short-distance wireless communication.

The processing information receiver 107 receives processing information from each of the devices 20-1 to 20-N. Specifically, the processing information receiver 107 receives processing information from the device 20 that has detected the mobile terminal 10. More specifically, the processing information receiver 107 receives processing information from the device 20, with which the short-distance wireless communication is established, over the short-distance wireless communication.

When the device 20, with which the short-distance wireless communication is established, has received error information rather than processing information from the information processing apparatus 30, the processing information receiver 107 receives the error information from the device 20 over the short-distance wireless communication.

The processing unit 109 executes, based on the plurality of pieces of processing information (the plurality of pieces of processing information received from the devices 20-1 to 20-N) received by the processing information receiver 107, predetermined processing which is made executable when the plurality of pieces of processing information are received.

The predetermined processing is processing which is made executable when processing information is received from all of the devices 20-1 to 20-N. Examples of the predetermined processing include, but are not limited to, at least any one of processing of removing a restriction on a function of an application, processing of acquiring a new application, processing of acquiring new data, processing of creating new data, and processing of executing a predetermined function of an application.

When pieces of processing information are not received from all of the devices 20-1 to 20-N and the predetermined processing is not executed yet, the processing unit 109 stores the processing information received by the processing information receiver 107 in the storage unit 105. At this time, the processing unit 109 stores the processing information in the storage unit 105 in association with the processing-information identification information indicating the processing information, date-and-time information regarding the processing information, and/or the like.

The present embodiment is described through an example where the processing information stored in the storage unit 303 of the information processing apparatus 30 or, put another way, the processing information received by the processing information receiver 107, contains the processing-information identification information identifying the processing information; and the processing unit 109 extracts the processing-information identification information from the processing information and stores the processing-information identification information in the storage unit 105 in association with the processing information. However, embodiments are not limited to this example.

The processing unit 109 may alternatively create, before pieces of processing information are received from all of the devices 20-1 to 20-N, new processing information from one or more pieces of processing information including latest received processing information and stores the created processing information in the storage unit 105 in association with processing-information identification information indicating the processing information, date-and-time information regarding the processing information, and/or the like.

The notification unit 111 provides a notification of receipt of processing information when the processing information is received by the processing information receiver 107, provides a notification of an error when error information is received by the processing information receiver 107, and provides a notification of a result of predetermined processing executed by the processing unit 109. In the present embodiment, the notification unit 111 provides (displays) these notifications on the display device 114; however, the method of providing the notification is not limited thereto.

Operations of the information processing system 1 of the present embodiment are described below with reference to specific examples. The description below is made through examples, in each of which N=3; however, the value of N is not limited thereto.

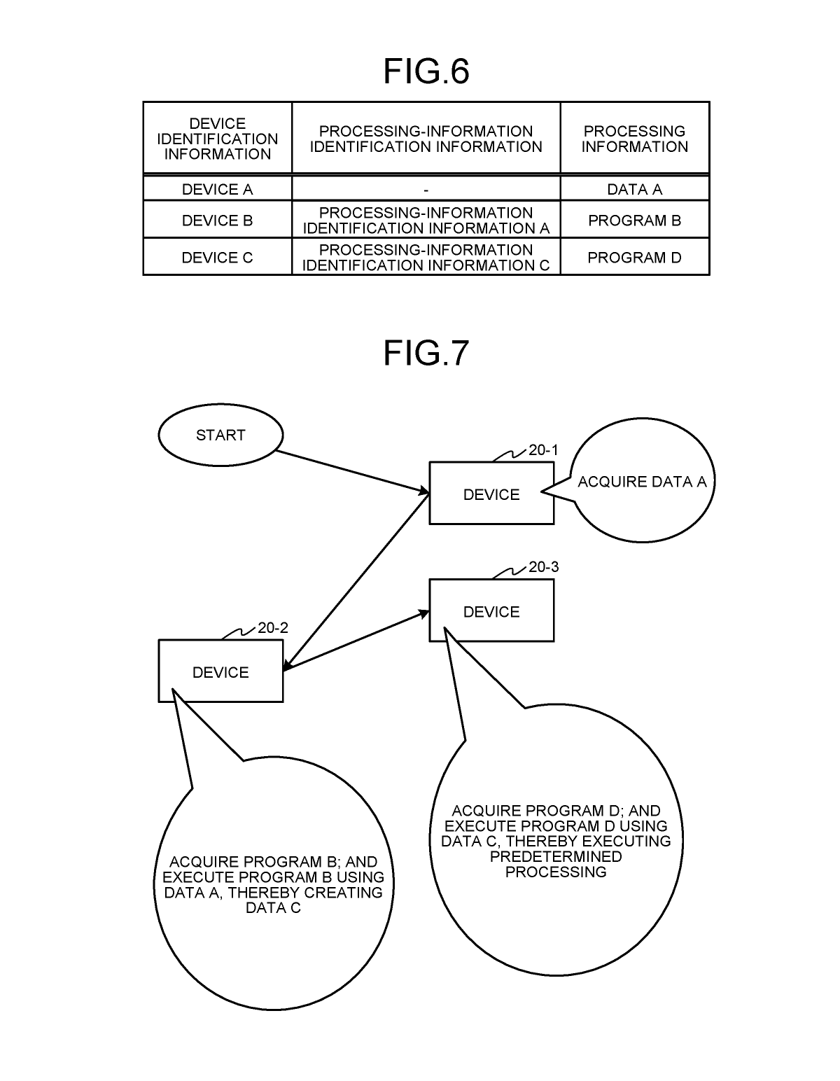

FIG. 6 is a diagram illustrating an example of information stored in the storage unit 303 of the present embodiment. The description below is made through examples, in each of which the storage unit 303 stores the information presented in FIG. 6; however, the information is not limited thereto. Device identification information “device A”, device identification information “device B”, and device identification information “device C” indicate, but are not limited to, the device 20-1, the device 20-2, and the device 20-3, respectively.

The information presented in FIG. 6 is designed such that processing information cannot be acquired at each of the devices 20 unless a user carrying the mobile terminal 10 moves to the devices 20 in the following order: the device 20-1, the device 20-2, and then the device 20-3 as illustrated in FIG. 7. In other words, in the information presented in FIG. 6, the pieces of processing-information identification information and the pieces of processing information are associated with the pieces of device identification information so that the above-described predetermined order is an order of the device 20-1, the device 20-2, and the device 20-3.

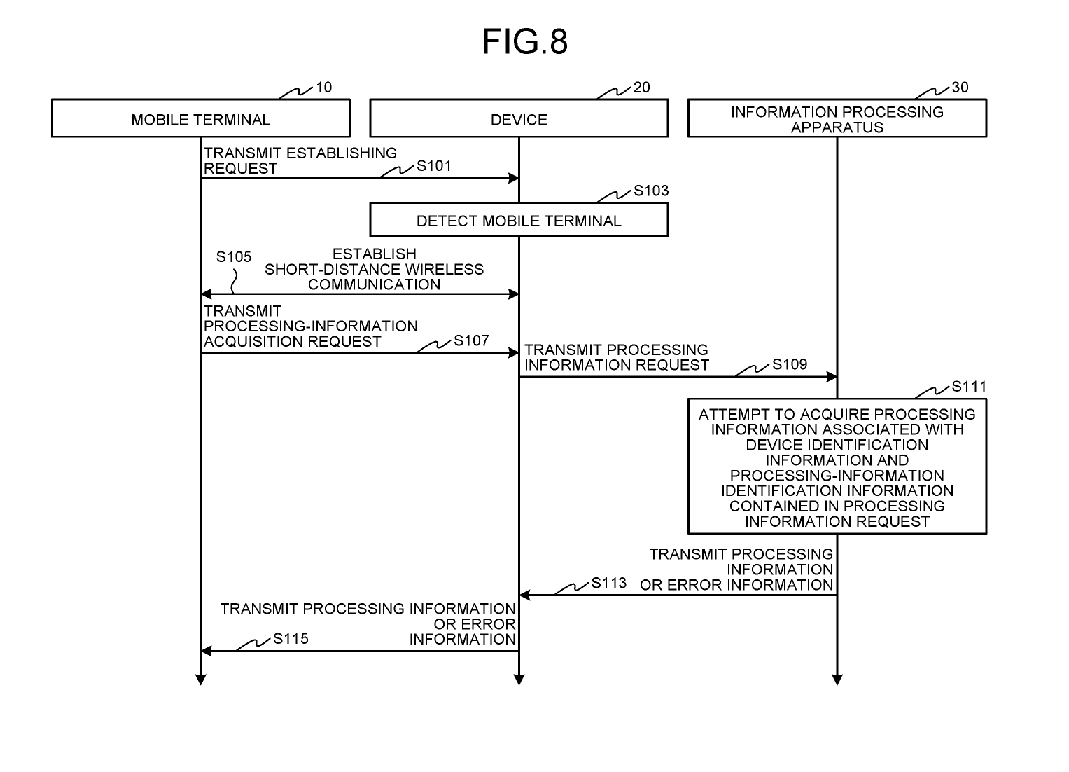

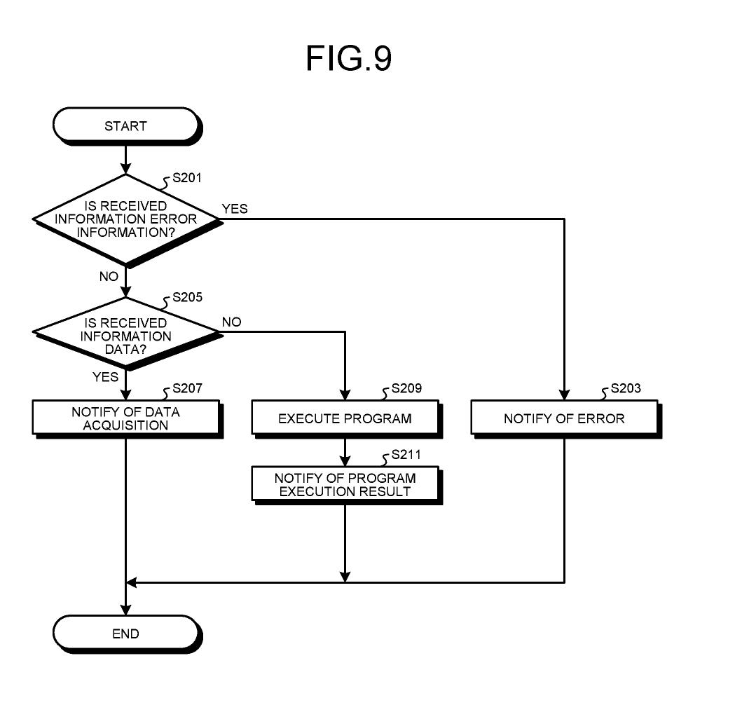

FIG. 8 is a sequence diagram illustrating an example of processing to be executed in the information processing system 1 of the present embodiment. FIG. 9 is a flowchart illustrating an example of processing to be executed when processing information or error information is received by the mobile terminal 10 of the present embodiment.

Operations of the information processing system 1 in a situation where a user carrying the mobile terminal 10 moves from a start point illustrated in FIG. 7 to the device 20-1 and acquires processing information from the device 20-1 using the mobile terminal 10 are described first with reference to the sequence diagram illustrated in FIG. 8 and the flowchart illustrated in FIG. 9.

The communication establishing unit 101 of the mobile terminal 10 transmits a request for establishing short-distance wireless communication based on an operation input by the user carrying the mobile terminal 10 using the input device 15, to the device 20-1 (S101).

Upon receiving the request for establishing short-distance wireless communication from the mobile terminal 10, the detection unit 201 of the device 20-1 detects the mobile terminal 10 (S103).

The detection unit 201 sends a response to the detected mobile terminal 10 and establishes short-distance wireless communication between the communication establishing unit 101 and the detection unit 201 (S105). Thereby, short-distance wireless communication between the mobile terminal 10 and the device 20-1 is enabled.

Thereafter, the processing-information-acquisition-request transmitter 103 of the mobile terminal 10 transmits a processing-information acquisition request to the device 20-1 over the short-distance wireless communication. The processing-information-acquisition-request receiver 203 of the device 20-1 receives the processing-information acquisition request (S107).

Because no received processing information is stored in the storage unit 105 of the mobile terminal 10 at this stage, processing-information identification information contained in the processing-information acquisition request indicates that no processing information is provided.

Thereafter, the processing-information-request transmitter 205 of the device 20-1 transmits a processing information request to the information processing apparatus 30 over the network 2. The processing-information-request receiver 301 of the information processing apparatus 30 receives the processing information request (S109).

The device identification information contained in the processing information request is “device A” indicating the device 20-1; the processing-information identification information contained in the same indicates that no processing information is provided as described earlier.

Thereafter, the processing information transmitter 305 of the information processing apparatus 30 retrieves processing information “data A” associated with the device identification information “device A” and with the processing-information identification information “no processing information”, both contained in the processing information request, from the storage unit 303 of the information processing apparatus 30 (S111).

Thereafter, the processing information transmitter 305 transmits the retrieved processing information “data A” to the device 20-1 over the network 2. The processing information receiver 209 of the device 20-1 receives the processing information (S113).

Thereafter, the processing information transmitter 211 of the device 20-1 transmits the processing information “data A” received by the processing information receiver 209 to the mobile terminal 10 over the short-distance wireless communication. The processing information receiver 107 of the mobile terminal 10 receives the processing information (S115).

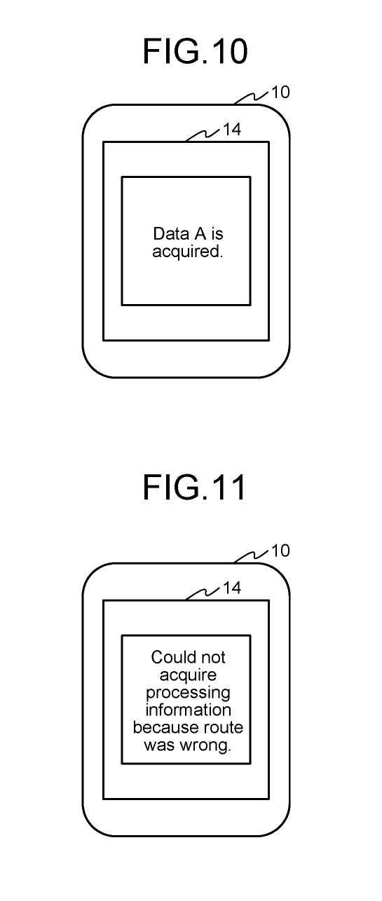

Because the received processing information “data A” is not error information (No at S201) but data (Yes at S205), the notification unit 111 provides a notification that “data A” is acquired on the display device 14 of the mobile terminal 10 as illustrated in FIG. 10 (S207).

The processing unit 109 extracts processing-information identification information “A” indicating “data A” from the received processing information “data A” and stores the processing-information identification information “A” in the storage unit 105 in association with the processing information “data A”, date-and-time information regarding the processing information “data A”, and/or the like.

Operations of the information processing system 1 in a situation where a user carrying the mobile terminal 10 moves from the start point illustrated in FIG. 7 to the device 20-2, without moving to the device 20-1, and acquires processing information from the device 20-2 using the mobile terminal 10 are described below with reference to the sequence diagram illustrated in FIG. 8 and the flowchart illustrated in FIG. 9.

The communication establishing unit 101 of the mobile terminal 10 transmits a request for establishing short-distance wireless communication based on an operation input by the user carrying the mobile terminal 10 using the input device 15, to the device 20-2 (S101).

Upon receiving the request for establishing short-distance wireless communication from the mobile terminal 10, the detection unit 201 of the device 20-2 detects the mobile terminal 10 (S103).

The detection unit 201 sends a response to the detected mobile terminal 10 and establishes short-distance wireless communication between the communication establishing unit 101 and the detection unit 201 (S105). Thereby, short-distance wireless communication between the mobile terminal 10 and the device 20-2 is enabled.

Thereafter, the processing-information-acquisition-request transmitter 103 of the mobile terminal 10 transmits a processing-information acquisition request to the device 20-2 over the short-distance wireless communication. The processing-information-acquisition-request receiver 203 of the device 20-2 receives the processing-information acquisition request (S107).

Because no received processing information is stored in the storage unit 105 of the mobile terminal 10 at this stage, processing-information identification information contained in the processing-information acquisition request indicates that no processing information is provided.

Thereafter, the processing-information-request transmitter 205 of the device 20-2 transmits a processing information request to the information processing apparatus 30 over the network 2. The processing-information-request receiver 301 of the information processing apparatus 30 receives the processing information request (S109).

The device identification information contained in the processing information request is “device B” indicating the device 20-2; the processing-information identification information contained in the same indicates that no processing information is provided as described earlier.

Because processing information that is associated with the device identification information “device B” and with the processing-information identification information “no processing information”, both contained in the processing information request, is not stored in the storage unit 303 of the information processing apparatus 30, the processing information transmitter 305 of the information processing apparatus 30 fails to acquire the processing information (S111).

Thereafter, because the processing information transmitter 305 has failed to acquire the processing information, the processing information transmitter 305 transmits error information to the device 20-2 over the network 2. The processing information receiver 209 of the device 20-2 receives the error information (S113).

Thereafter, the processing information transmitter 211 of the device 20-2 transmits the error information received by the processing information receiver 209 to the mobile terminal 10 over the short-distance wireless communication. The processing information receiver 107 of the mobile terminal 10 receives the error information (S115).

Because the received error information is error information (Yes at S201), the notification unit 111 provides a notification that acquisition of processing information has failed because of a wrong moving route on the display device 14 of the mobile terminal 10 as illustrated in FIG. 11 (S203).

Operations of the information processing system 1 in a situation where the user carrying the mobile terminal 10 moves from the device 20-1 to the device 20-2 illustrated in FIG. 7 and acquires processing information from the device 20-2 using the mobile terminal 10 are described below with reference to the sequence diagram illustrated in FIG. 8 and the flowchart illustrated in FIG. 9.

The communication establishing unit 101 of the mobile terminal 10 transmits a request for establishing short-distance wireless communication based on an operation input by the user carrying the mobile terminal 10 using the input device 15, to the device 20-2 (S101).

Upon receiving the request for establishing short-distance wireless communication from the mobile terminal 10, the detection unit 201 of the device 20-2 detects the mobile terminal 10 (S103).

The detection unit 201 sends a response to the detected mobile terminal 10 and establishes short-distance wireless communication between the communication establishing unit 101 and the detection unit 201 (S105). Thereby, short-distance wireless communication between the mobile terminal 10 and the device 20-2 is enabled.

Thereafter, the processing-information-acquisition-request transmitter 103 of the mobile terminal 10 transmits a processing-information acquisition request to the device 20-2 over the short-distance wireless communication. The processing-information-acquisition-request receiver 203 of the device 20-2 receives the processing-information acquisition request (S107).

Because the processing information “data A” is stored in the storage unit 105 of the mobile terminal 10 as received processing information at this stage, the processing-information acquisition request contains the processing-information identification information “A”.

Thereafter, the processing-information-request transmitter 205 of the device 20-2 transmits a processing information request to the information processing apparatus 30 over the network 2. The processing-information-request receiver 301 of the information processing apparatus 30 receives the processing information request (S109).

The device identification information contained in the processing information request is “device B” indicating the device 20-2; the processing-information identification information contained in the same is the processing-information identification information “A” as described earlier.

Thereafter, the processing information transmitter 305 of the information processing apparatus 30 retrieves processing information “program B” associated with the device identification information “device B” and with the processing-information identification information “A”, both contained in the processing information request, from the storage unit 303 of the information processing apparatus 30 (S111).

Thereafter, the processing-information-request transmitter 205 transmits the retrieved processing information “program B” to the device 20-2 over the network 2. The processing information receiver 209 of the device 20-2 receives the processing information (S113).

Thereafter, the processing information transmitter 211 of the device 20-2 transmits the processing information “program B” received by the processing information receiver 209 to the mobile terminal 10 over the short-distance wireless communication. The processing information receiver 107 of the mobile terminal 10 receives the processing information (S115).

Because the received processing information “program B” is neither error information (No at S201) nor data (No at S205), the processing unit 109 retrieves the processing information “data A” from the storage unit 105 and executes the processing information “program B” using the retrieved processing information “data A”, thereby creating processing information “data C” (S209). In this example, it is assumed that the processing information used in executing the processing information “program B” is defined in the processing information “program B” and is the processing information “data A” in this example.

Thereafter, the notification unit 111 provides a notification that the processing information “data C” is created by execution of the processing information “program B” on the display device 14 of the mobile terminal 10 (S211). The notification unit 111 may also provide a notification that the processing information “program B” is acquired.

The processing unit 109 extracts processing-information identification information “C” indicating “data C” from the created processing information “data C” and stores the processing-information identification information “C” in the storage unit 105 in association with the processing information “data C”, date-and-time information regarding the processing information “data C”, and/or the like. The processing unit 109 may further store information regarding the received processing information “program B” in the storage unit 105.

Operations of the information processing system 1 in a situation where the user carrying the mobile terminal 10 moves from the device 20-2 to the device 20-3 illustrated in FIG. 7 and acquires processing information from the device 20-3 using the mobile terminal 10 are described below with reference to the sequence diagram illustrated in FIG. 8 and the flowchart illustrated in FIG. 9.

The communication establishing unit 101 of the mobile terminal 10 transmits a request for establishing short-distance wireless communication based on an operation input by the user carrying the mobile terminal 10 using the input device 15, to the device 20-3 (S101).

Upon receiving the request for establishing short-distance wireless communication from the mobile terminal 10, the detection unit 201 of the device 20-3 detects the mobile terminal 10 (S103).

The detection unit 201 sends a response to the detected mobile terminal 10 and establishes short-distance wireless communication between the communication establishing unit 101 and the detection unit 201 (S105). Thereby, short-distance wireless communication between the mobile terminal 10 and the device 20-3 is enabled.

Thereafter, the processing-information-acquisition-request transmitter 103 of the mobile terminal 10 transmits a processing-information acquisition request to the device 20-3 over the short-distance wireless communication. The processing-information-acquisition-request receiver 203 of the device 20-3 receives the processing-information acquisition request (S107).

At this stage, at least the processing information “data A” and the processing information “data C” are stored in the storage unit 105 of the mobile terminal 10 as received processing information. Because the pieces of date-and-time information indicate that latest processing information (processing information derived from latest received processing information) is the processing information “data C”, the processing-information acquisition request contains the processing-information identification information “C”.

Thereafter, the processing-information-request transmitter 205 of the device 20-3 transmits a processing information request to the information processing apparatus 30 over the network 2. The processing-information-request receiver 301 of the information processing apparatus 30 receives the processing information request (S109).

The device identification information contained in the processing information request is “device C” indicating the device 20-3; the processing-information identification information contained in the same is the processing-information identification information “C” as described earlier.

Thereafter, the processing information transmitter 305 of the information processing apparatus 30 retrieves processing information “program D” associated with the device identification information “device C” and with the processing-information identification information “C”, both contained in the processing information request, from the storage unit 303 of the information processing apparatus 30 (S111).

Thereafter, the processing-information-request transmitter 205 transmits the retrieved processing information “program D” to the device 20-3 over the network 2. The processing information receiver 209 of the device 20-3 receives the processing information (S113).

Thereafter, the processing information transmitter 211 of the device 20-3 transmits the processing information “program D” received by the processing information receiver 209 to the mobile terminal 10 over the short-distance wireless communication. The processing information receiver 107 of the mobile terminal 10 receives the processing information (S115).

Because the received processing information “program D” is neither error information (No at S201) nor data (No at S205), the processing unit 109 retrieves the processing information “data C” from the storage unit 105 and executes the processing information “program D” using the retrieved processing information “data C”, thereby executing predetermined processing. In this example, it is assumed that the processing information used in executing the processing information “program D” is defined in the processing information “program D”, and is the processing information “data C” in this example.

In this example, the predetermined processing is processing of removing a restriction placed on a function of an application (for example, processing of unlocking a function that has been locked and unusable, thereby making the function usable). Alternatively, as described earlier, the predetermined processing may be processing of acquiring a new application, processing of acquiring new data, processing of creating new data, processing of executing a predetermined function of an application, or the like. When the predetermined processing is processing of acquiring a new application or processing of acquiring new data, the processing unit 109 may acquire the new application or the new data from the information processing apparatus 30 over the network 2, for example.

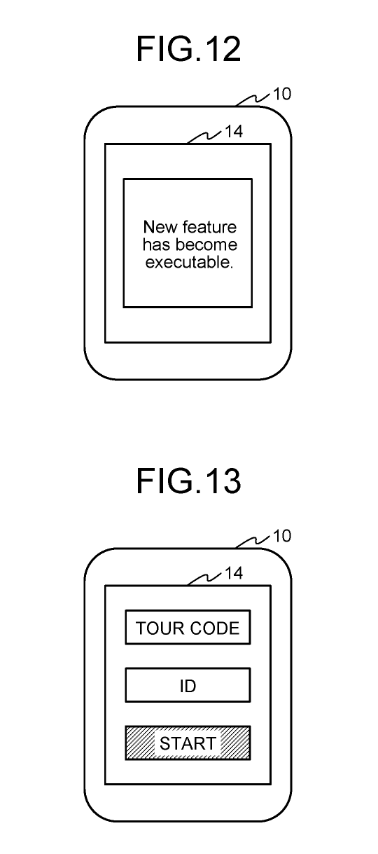

Thereafter, the notification unit 111 provides a notification that execution of a new function is enabled by execution of the processing information “program D” on the display device 14 of the mobile terminal 10 as illustrated in FIG. 12 (S211). The notification unit 111 may also provide a notification that the processing information “program D” is acquired.

As described above, according to the present embodiment, the predetermined processing is made executable only when a user has moved to all the devices 20-1 to 20-N. Hence, a condition for making the predetermined processing executable can be made complex. In particular, according to the present embodiment, the predetermined processing is made executable only when the user moves to the devices 20-1 to 20-N in the predetermined order. Hence, a condition for making the predetermined processing executable can be made more complex.

As described above, because a condition for making a predetermined processing executable can be made complex, the present embodiment is applicable to gamified systems, such as a stamp rally. Examples of the predetermined processing to be executed in this case include processing of permitting only a participant(s) having collected all stamps to view certain content (which is an example of the processing of removing a restriction on a function or the processing of acquiring a new application) and processing of delivering certain data only to a participant(s) having collected all the stamps (which is an example of the processing of acquiring new data and the processing of creating new data.)

According to the present embodiment, because a condition for making a predetermined processing executable can be made complex, it is possible to automate execution of the predetermined processing even if a condition for executing the predetermined processing is complicated.

For instance, assume a situation where it is desired to encourage participants of a package tour using airplane as a form of transportation, to participate in an optional tour. A participant of the package tour executes an application provided by a package tour provider on the mobile terminal 10, enters an optional tour's ID and a participant ID, and views description of the optional tour to apply to participate in the optional tour. However, these operations are cumbersome and undesirably discourage potential participants from participating in the optional tour.

In the above situation, it is highly likely that the package tour's participant moves from a desk of the package tour provider to a security checkpoint, and then to a boarding gate in an airport. When the package tour's participant moves to the desk of the package tour provider, the device 20 placed on the desk delivers the application, which is provided by the package tour provider, to the mobile terminal 10 of the package tour's participant as processing information. When the package tour's participant moves to the security checkpoint, the device 20 placed at the security checkpoint delivers the optional tour's ID to the mobile terminal 10 of the package tour's participant as processing information. When the package tour's participant moves to the boarding gate, the device 20 placed at the boarding gate delivers the participant ID to the mobile terminal 10 of the package tour's participant as processing information.

When the participant ID has been delivered, the application is executed on the mobile terminal 10 (an example of processing of executing a predetermined function), and a screen where the optional tour's ID and the participant ID are already entered is displayed as illustrated in FIG. 13. Hence, the participant can view the description of the optional tour and apply to participate in the optional tour without performing cumbersome operations.

### First Modification

While the embodiment has been described through the example where the order of the devices 20-1 to 20-N in which movement is made is taken into consideration, the embodiment can be modified such that the predetermined processing is made executable simply on condition that the movement to all the devices 20-1 to 20-N is made irrespective of the order of the devices 20-1 to 20-N in which movement is made.

This first modification can be achieved by not storing the processing-information identification information in the storage unit 303 and not causing the processing-information identification information to be contained in the processing-information acquisition request and in the processing information request. In short, the first modification can be achieved by configuring the information processing apparatus 30 to transmit processing information associated with the device identification information contained in the processing information request.

The first modification may alternatively be implemented in the following manner. The processing-information identification information is not stored in the storage unit 303; and all already-acquired pieces of processing-information identification information are contained in each of the processing-information acquisition request and the processing information request. The information processing apparatus 30 transmits the processing information associated with the device identification information contained in the processing information request only when the processing information associated with the device identification information contained in the processing information request matches none of pieces of processing information indicated by the pieces of processing-information identification information contained in the processing information request. This configuration can advantageously prevent redundant transmission of the processing information.

### Second Modification

The embodiment can be modified as follows. The storage unit 303 additionally associates device identification information indicating a device of the next movement destination with the processing information (in the example illustrated in FIG. 6, associates the device identification information “device B” with the processing information “data A”; associates the device identification information “device C” with the processing information “program B”). The information processing apparatus 30 transmits the processing information together with the device identification information. The notification unit 111 of the mobile terminal 10 provides a notification using the device identification information.

For instance, when the mobile terminal 10 receives the processing information “data A”, the notification unit 111 may provide a notification indicating not only that “data A” is acquired but also that the next movement destination is the device 20-2 indicated by the device identification information “device B”. With this second modification, a user can be informed of the next movement destination.

The second modification may alternatively be implemented in the following manner. Rather than the device identification information indicating the device of the next movement destination, location information indicating a location of the device of the next movement destination is additionally associated with the processing information. The information processing apparatus 30 transmits the processing information together with the location information. The notification unit 111 of the mobile terminal 10 provides a notification using the location information.

For instance, the notification may be provided in coordination with a map application such that the notification unit 111 provides the notification of the location indicated by the location information on the map application. With this configuration, a user can be informed of the next movement destination in detail.

Each of programs to be executed by the mobile terminal 10, the devices 20, and the information processing apparatus 30 (hereinafter, “the devices of the embodiment”) may be stored in a non-transitory computer-readable storage medium, such as a CD-ROM, a CD-R, a memory card, a DVD (Digital Versatile Disk), and a flexible disk (FD), as an installable file or an executable file to provide the program.

Each of the programs to be executed by the devices of the embodiment may be configured to be stored in a computer connected to a network, such as the Internet, and downloaded over the network to provide the program. Each of the programs to be executed by the devices of the embodiment may be configured to be provided or delivered over a network, such as the Internet. Each of the programs to be executed by the devices of the embodiment may be installed on a ROM or the like in advance to provide the program.

Each of the programs to be executed by the devices of the embodiment is configured in modules for implementing the units described above on a computer. From an actual hardware perspective, a CPU loads the program from a ROM into a RAM and executes the program, thereby implementing the functional units described above on the computer.

According to an embodiment, a condition for making a predetermined processing executable can be made complex.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing system comprising:
a plurality of devices;
an information processing apparatus; and
a mobile terminal,
each of the plurality of devices including:
a detection unit configured to detect the mobile terminal;
a processing-information-request transmitter configured to transmit a processing information request containing device identification information identifying the device, to the information processing apparatus based on detection of the mobile terminal by the detection unit;
a first processing-information receiver configured to receive processing information associated with the device identification information contained in the processing information request, from the information processing apparatus; and
a first processing-information transmitter configured to transmit the processing information to the mobile terminal,
the information processing apparatus including:
a processing-information-request receiver configured to receive the processing information request from each of the plurality of devices; and
a second processing-information transmitter configured to retrieve, from a storage unit configured to store different pieces of processing information in association with respective pieces of device identification information, processing information associated with the device identification information contained in the received processing information request and transmit the processing information to the device, from which the processing information request has been transmitted,
the mobile terminal including:
a second processing-information receiver configured to receive processing information from each of the plurality of devices; and
a processing unit configured to execute predetermined processing which is made executable if a plurality of pieces of processing information are received from the plurality of devices, based on the plurality of pieces of processing information.

2. The information processing system according to claim 1, wherein
the mobile terminal further includes a processing-information-acquisition-request transmitter configured to transmit a processing-information acquisition request containing processing-information identification information identifying processing information derived from latest received processing information, to the device having detected the mobile terminal,
each of the plurality of devices further includes a processing-information-acquisition-request receiver configured to receive the processing-information acquisition request from the mobile terminal,
the processing information request further contains the processing-information identification information contained in the processing-information acquisition request,
the storage unit further stores different pieces of processing-information identification information in association with respective pieces of device identification information, and
the second processing-information transmitter retrieves processing information associated with the device identification information and with the processing-information identification information, both the device identification information and the processing-information identification information being contained in the received processing-information request, from the storage unit.

3. The information processing system according to claim 2, further comprising a notification unit, wherein
if processing information associated with the device identification information and with the processing-information identification information, both contained in the received processing-information request, is not stored in the storage unit, the second processing-information transmitter transmits error information to the device, from which the device identification information has been transmitted,
the first processing-information receiver receives the error information from the information processing apparatus,
the first processing-information transmitter transmits the error information to the mobile terminal,
the second processing-information receiver receives the error information from the device, and
the notification unit provides an error notification if the error information is received.

4. The information processing system according to claim 2, wherein the pieces of processing-information identification information and the pieces of processing information are associated with the pieces of device identification information in the storage unit so as to make an order in which a user carrying the mobile terminal moves to the plurality of devices, a predetermined order.

5. The information processing system according to claim 2, wherein the processing information derived from the latest received processing information is any one of the latest received processing information and processing information created from one or more pieces of processing information including the latest received processing information.

6. The information processing system according to claim 1, wherein the processing information is at least any one of data and a program.

7. The information processing system according to claim 1, wherein the predetermined processing is at least any one of processing of removing a restriction on a function of an application, processing of acquiring a new application, processing of acquiring new data, processing of creating new data, and processing of executing a predetermined function of an application.

8. An information processing system comprising:
an information processing apparatus; and
a mobile terminal,
the information processing apparatus including:
a request receiver configured to receive, from a device of a plurality of devices, the device having detected the mobile terminal, a processing information request containing device identification information identifying the device; and
a processing information transmitter configured to retrieve, from a storage unit configured to store different pieces of processing information in association with respective pieces of device identification information, processing information associated with the device identification information contained in the received processing information request and transmit the processing information to the device,
the mobile terminal including:
a processing information receiver configured to receive the processing information from each of the plurality of devices; and
a processing unit configured to execute predetermined processing which is made executable if a plurality of pieces of processing information are received from the plurality of devices, based on the plurality of pieces of processing information.

9. An information processing method to be performed by an information processing system including a plurality of devices, an information processing apparatus, and a mobile terminal, the information processing method comprising:
by each of the plurality of devices,
detecting the mobile terminal;
transmitting a processing information request containing device identification information identifying the device, to the information processing apparatus based on detection of the mobile terminal;
receiving processing information associated with the device identification information contained in the processing information request, from the information processing apparatus;
transmitting the processing information to the mobile terminal;
by the information processing apparatus,
receiving the processing information request from each of the plurality of devices;
retrieving, from a storage unit configured to store different pieces of processing information in association with respective pieces of device identification information, processing information associated with the device identification information contained in the received processing information request and transmitting the processing information to the device, from which the processing information request has been transmitted;
by the mobile terminal,
receiving processing information from each of the plurality of devices; and
executing predetermined processing which is made executable if a plurality of pieces of processing information are received from the plurality of devices, based on the plurality of pieces of processing information.

10. The information processing method according to claim 9, further comprising
transmitting, by the mobile terminal, a processing-information acquisition request containing processing-information identification information identifying processing information derived from latest received processing information, to the device having detected the mobile terminal,
receiving, by each of the plurality of devices, the processing-information acquisition request from the mobile terminal, wherein
the processing information request further contains the processing-information identification information contained in the processing-information acquisition request,
the storage unit further stores different pieces of processing-information identification information in association with respective pieces of device identification information, and
at the retrieving, processing information associated with the device identification information and with the processing-information identification information, both the device identification information and the processing-information identification information being contained in the received processing-information request, is retrieved from the storage unit.

11. The information processing method according to claim 10, wherein
at the transmitting the processing information by the information processing apparatus, if processing information associated with the device identification information and with the processing-information identification information, both contained in the received processing-information request, is not stored in the storage unit, error information is transmitted to the device, from which the device identification information has been transmitted,
at the receiving the processing information by each of the plurality of devices, the error information is received from the information processing apparatus,
at the transmitting the processing information by each of the plurality of devices, the error information is transmitted to the mobile terminal,
at the receiving the processing information by the mobile terminal, the error information is received from the device, and
the method further comprises providing an error notification if the error information is received.

12. The information processing method according to claim 10, wherein the pieces of processing-information identification information and the pieces of processing information are associated with the pieces of device identification information in the storage unit so as to make an order in which a user carrying the mobile terminal moves to the plurality of devices, a predetermined order.

13. The information processing method according to claim 10, wherein the processing information derived from the latest received processing information is any one of the latest received processing information and processing information created from one or more pieces of processing information including the latest received processing information.

14. The information processing method according to claim 9, wherein the processing information is at least any one of data and a program.

15. The information processing method according to claim 9, wherein the predetermined processing is at least any one of processing of removing a restriction on a function of an application, processing of acquiring a new application, processing of acquiring new data, processing of creating new data, and processing of executing a predetermined function of an application.
